(19) United States
(12) Patent Application Publication
(10) Pub. No.: US 2025/0228392 A1
(43) Pub. Date: Jul. 17, 2025

(54) WATER PURIFIER AND CONTROL METHOD THEREFOR

(71) Applicant: Samsung Electronics Co., Ltd., Suwon-si (KR)

(72) Inventors: Jungeun SEO, Suwon-si (KR); Deulre MIN, Suwon-si (KR); Hoon WEE, Suwon-si (KR)

(21) Appl. No.: 19/169,673

(22) Filed: Apr. 3, 2025

Related U.S. Application Data
(63) Continuation of application No. PCT/KR2023/014280, filed on Sep. 20, 2023.

(30) Foreign Application Priority Data
Nov. 10, 2022 (KR) 10-2022-0149942

(51) Int. Cl. A47J 31/52; A23F 3/18; A47J 31/56; C02F 1/00

(52) U.S. Cl. CPC A47J 31/5253; A23F 3/18; A47J 31/56; C02F 1/003

(57) ABSTRACT

A water purifier may include a filter for filtering water introduced from an outside, a storage tank for storing the water filtered by the filter, a heat exchanger for controlling a temperature of the water inside the storage tank; a temperature sensor capable of detecting the temperature of the water inside the storage tank, a water supply for supplying the water filtered by the filter to a user; a communication interface, an output for providing information about tea to the user, a memory for storing at least one instruction, and one or more processors capable of executing the at least one instruction. The one or more processors may be configured to, based on the information about the tea being received through the communication interface, identify a type of the tea based on the received information, identify a method of manufacturing the tea based on the identified type of the tea, control, the heat exchange unit such that the temperature of the water inside the storage tank reaches a predetermined temperature based on the identified preparation method, and based on the temperature of the water inside the storage tank detected through the temperature sensor being identified as the predetermined temperature, control the water supply to provide the water inside the storage tank to the user.

### CROSS-REFERENCE TO RELATED APPLICATIONS

This application is a continuation application of International Application No. PCT/KR2023/014280 designating the United States, filed on Sep. 20, 2023, in the Korean Intellectual Property Receiving Office and claiming priority to Korean Patent Application No. 10-2022-0149942, filed on Nov. 10, 2022, the disclosures of which are all hereby incorporated by reference herein in their entireties.

### BACKGROUND

### Technical Field

Certain example embodiments may relate to a water purifier and/or a control method therefor and, for example, to a water purifier which identifies a manufacturing method according to a type of tea and provides a method of infusing tea in optimum conditions and/or a control method therefor.

### Description of Related Art

A water purifier includes a filter, a storage tank, a temperature controller (a heating unit or a cooling unit), a water supply nozzle, or the like and may provide drinking water in various temperature conditions to a user. Therefore, the user may be provided with water of various temperatures suited to a taste and a purpose through the water purifier.

As tastes and purposes of the user diversify, the demand for enjoying favorite food using water such as coffee or tea in optimum conditions has increased, wherein the water purifier may take a role of providing water suitable for manufacturing the favorite food and furthermore, assisting the user in manufacturing the favorite food using water overall.

### SUMMARY

According to an example embodiment, a water purifier may include a filter for filtering water introduced from an outside, a storage tank for storing the water filtered by the filter, a heat exchanging unit for controlling a temperature of the water inside the storage tank, a temperature sensor capable of detecting the temperature of the water inside the storage tank, a water supply unit for supplying the water filtered by the filter to a user, a communication interface comprising communication circuitry, an output unit for providing information about tea to the user, memory for storing at least one instruction, and one or more processors comprising processing circuitry capable of executing the at least one instruction, wherein the one or more processors are configured to individually and/or collectively, based on the information about the tea being received through the communication interface, identify a type of the tea based on the received information, identify a method of manufacturing the tea based on the identified type of the tea, control the heat exchanging unit such that the temperature of the water inside the storage tank reaches a predetermined temperature based on the identified manufacturing method, and based on the temperature of the water inside the storage tank detected through the temperature sensor being identified as the predetermined temperature, control the water supply unit to provide the water inside the storage tank to the user.

Meanwhile, the one or more processors may identify at least one of a component of water for infusing the tea, a temperature of water for infusing the tea, a time for infusing the tea, or optimum capacity of the tea.

Meanwhile, the one or more processors, based on the temperature of the water inside the storage tank detected through the temperature sensor being identified as the predetermined temperature, may control the output unit to provide a notification that preparation for infusing the tea is completed to the user.

Meanwhile, the one or more processors, based on a predetermined time being elapsed from a time point when the water inside the storage tank is provided to the user based on the method of manufacturing the tea, may control the output unit to provide a notification that infusion of the tea is completed to the user.

Meanwhile, the one or more processors, based on the temperature of the water inside the storage tank detected through the temperature sensor being identified as the predetermined temperature, may control the water supply unit to provide water of a volume corresponding to optimum capacity of the tea among the water inside the storage tank to the user based on the method of manufacturing the tea.

Meanwhile, the one or more processors, based on information about a plurality of tea being received through the communication interface, may identify a type of the plurality of tea based on the received information, identify a method of blending the plurality of tea based on the identified type of the plurality of tea, and identify a method of manufacturing the blended tea based on the identified blending method.

Meanwhile, the one or more processors, based on evaluation information about the tea being received from the user, store information about a corrected method of manufacturing the tea based on the evaluation information, wherein the evaluation information is information about at least one of a concentration of the tea or a taste of the tea.

Meanwhile, the one or more processors may control the output unit to provide information about at least one of a component of water for infusing the tea, a temperature of water for infusing the tea, a time for infusing the tea, or optimum capacity of the tea based on the identified type of the tea.

Meanwhile, the one or more processors may identify food corresponding to the tea based on the identified type of the tea, and control the output unit to provide information about the identified food to the user.

According to an example embodiment of the disclosure, a method of controlling a water purifier may include, based on information about tea being received, identifying a type of the tea based on the received information, identifying a method of manufacturing the tea based on the identified type of the tea, controlling the water purifier such that a temperature of water inside a storage tank reaches a predetermined temperature based on the identified manufacturing method, and based on the temperature of the water inside the storage tank being identified as the predetermined temperature, providing the water inside the storage tank to a user.

Meanwhile, the identifying the manufacturing method may include identifying at least one of a characteristic of water for infusing the tea, a temperature of water for infusing the tea, a time for infusing the tea, or optimum capacity of the tea.

Meanwhile, the control method may include, based on the temperature of the water inside the storage tank being identified as the predetermined temperature, providing a notification that preparation for infusing the tea is completed to the user.

Meanwhile, the control method may include, based on the predetermined time being elapsed from a time point when the water inside the storage tank is provided to the user based on the method of manufacturing the tea, providing a notification that infusion of the tea is completed to the user.

Meanwhile, the providing the water may include, based on the temperature of the water inside the storage tank being identified as the predetermined temperature, providing water of a volume corresponding to optimum capacity of the tea among the water inside the storage tank to the user based on the method of manufacturing the tea.

Meanwhile, the identifying the type of the tea may include, based on information about a plurality of tea being received, identifying a type of the plurality of tea based on the received information, and the identifying the method of manufacturing the tea may include identifying a method of blending the plurality of tea based on the identified type of the plurality of tea and identifying a method of manufacturing the blended tea based on the identified blending method.

Meanwhile, the control method may include, based on evaluation information about the tea being received from the user, storing information about a corrected method of manufacturing the tea based on the evaluation information, wherein the evaluation information may be information about at least one of a concentration of the tea or a taste of the tea.

Meanwhile, the control method may include providing information about at least one of a component of water for infusing the tea, a temperature of water for infusing the tea, a time for infusing the tea, or optimum capacity of the tea based on the identified type of the tea.

Meanwhile, the control method may include identifying food corresponding to the tea based on the identified type of the tea, and providing information about the identified food to the user.

According to an example embodiment, a non-transitory computer readable recording medium storing computer instructions that, when executed by a processor of a water purifier, cause the water purifier to, based on information about tea being received, identifying a type of the tea based on the received information, identify a method of manufacturing the tea based on the identified type of the tea, control the water purifier such that a temperature of water inside the water purifier reaches a predetermined temperature based on the identified manufacturing method, and based on the temperature of the water inside the water purifier being identified as the predetermined temperature, provide the water inside the water purifier to a user.

According to an example embodiment of the disclosure, a system including a user terminal and a water purifier may include the water purifier that, based on an image being obtained, identifies a text included in the image and identifies information about tea among the identified text, and based on information about a user terminal transmitting the identified information about the tea to the water purifier and information about the tea being received, identifies a type of the tea based on the received information, identifies a method of manufacturing the tea based on the identified type of the tea, and controls the water purifier such that a temperature of water inside the water purifier reaches a predetermined temperature based on the identified manufacturing method, and based on the temperature of water inside the water purifier being identified as the predetermined temperature, provides the water inside the water purifier to the user.

### BRIEF DESCRIPTION OF DRAWINGS

An aspect, a characteristic, and an advantage of an example embodiment(s) is more clarified by the after-mentioned description with reference to the appended drawings.

FIG. 1 is a view illustrating a water purifier and a user terminal according to an example embodiment;

FIG. 2 is a block diagram illustrating a configuration of a water purifier according to an example embodiment;

FIG. 3 is a sequence diagram illustrating operations of a water purifier and a user terminal according to an example embodiment;

FIG. 4 is a view illustrating operations of obtaining an image in which a wrapper of tea is photographed and identifying a text included in the image through the user terminal according to an example embodiment;

FIG. 5 is a view illustrating a database including information about tea according to an example embodiment;

FIG. 6 is a view illustrating an operation in which a water purifier provides a notification that preparation for infusing tea is completed to a user through an output unit according to an example embodiment;

FIG. 7 is a view illustrating an operation in which a water purifier provides water to a user through a water supply unit according to an example embodiment;

FIG. 8 is a view illustrating an operating in which a water purifier provides a notification that infusion of tea is completed to a user through an output unit according to an example embodiment;

FIG. 9 is a view illustrating an operation in which a water purifier obtains information about a blending ratio of a plurality of tea through a tea blending optimization model according to an example embodiment;

FIG. 10 is a view illustrating an operation of receiving evaluation information about tea from a user according to an example embodiment; and

FIG. 11 is a flow chart illustrating an operation of a water purifier according to an example embodiment.

### DETAILED DESCRIPTION

Embodiments of the disclosure may be modified in various different forms and may have various embodiments, wherein specific embodiments will be exemplified in the drawings and specifically explained in the detailed description. However, it should be noted that the various embodiments are not for limiting the scope of the disclosure to a specific embodiment but they should be interpreted to include all modifications, equivalents, and/or alternatives of the embodiments of the disclosure. With respect to the description of the drawings, similar components may be designated by similar reference numerals.

In case it is determined that in describing the disclosure, the detailed description of related known functions or configurations may unnecessarily confuse the gist of the disclosure, the detailed description thereof will be omitted.

In addition, the embodiments below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

The terms used in the disclosure are used only to explain specific embodiments and are not intended to limit the scope of the disclosure. A singular expression includes a plural expression, unless obviously differently defined in the context.

In the disclosure, the expression such as “have,” “may have,” “include”, or “may include” denotes the existence of such a characteristic (e.g. a numerical value, a function, an operation, or a component such as a part), and the expression does not exclude the existence of an additional characteristic.

In the disclosure, the expression “A or B”, “at least one of A and/or B”, “one or more of A and/or B”, or the like may include all possible combinations of the listed items. For example, “A or B”, “at least one of A and B”, or “at least one of A or B” may refer to all of the following cases: (1) including at least one A, (2) including at least one B, or (3) including all of at least one A and at least one B.

The expression “1st”, “2nd”, “first”, “second”, or the like used in the disclosure may be used to describe various elements regardless of any order and/or degree of importance, wherein the expression is used only to distinguish one element from another element and is not intended to limit the elements.

Meanwhile, the description that one element (e.g. a first element) is “(operatively or communicatively) coupled with/to” or “connected to” another element (e.g. a second element) should be interpreted to include both the case where the one element is directly coupled to the another element, and the case where the one element is coupled to the another element through at least the other element(s) (e.g. a third element). Thus, for example, “connected” as used herein covers both direct and indirect connections.

In contrast, the description that one element (e.g. a first component) is “directly coupled” or “directly connected” to another element (e.g. a second component) may be interpreted such that the other element (e.g. a third component) is not present between the one element and the another element.

The expression “configured to” used in the disclosure may be interchangeably used with other expressions, for example, “suitable for”, “having the capacity to”, “designed to”, “adapted to”, “made to”, or “capable of” depending on circumstances. The term “configured to (or set to)” may not necessarily mean that a device is “specifically designed to” do in terms of hardware.

Instead, under some circumstances, the expression “a device configured to” may indicate that the device “is capable of” performing an operation together with another device or component. For example, the phrase “a processor configured to (set to) perform A, B, and C” may indicate a dedicated processor for performing the corresponding operations (e.g. an embedded processor), or a generic-purpose processor that may perform the corresponding operations by executing one or more software programs stored in a memory device (e.g. a CPU or an application processor).

In embodiments of the disclosure, a ‘module’ or ‘part’ may perform at least one function or operation and may be implemented as hardware or software, or as a combination of hardware and software. Also, a plurality of ‘modules’ or ‘parts’ may be integrated into at least one module and implemented as at least one processor, excluding a ‘module’ or ‘part’ that needs to be implemented as specific hardware. Thus, each “module” herein may comprise circuitry.

Meanwhile, various elements and areas in the drawings are illustrated schematically. Accordingly, the technical idea of the disclosure is not limited by the relative sizes or intervals illustrated in the appended drawings.

Hereinafter, with reference to the appended drawings, an embodiment according to the disclosure is specifically described to be easily embodied by those skilled in the art.

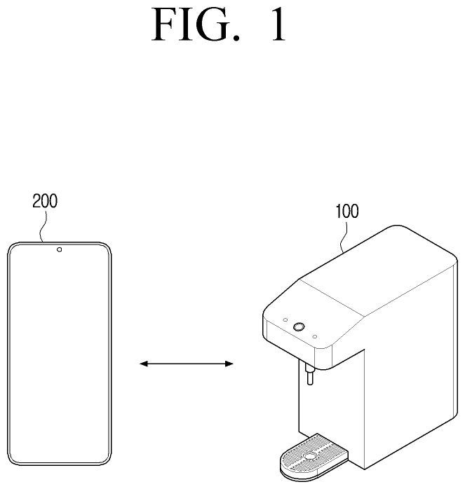

FIG. 1 is a view illustrating a water purifier and a user terminal according to an embodiment.

With reference to FIG. 1, a water purifier 100 may be a device providing drinking water according to various temperature conditions to a user. A water purifier 100 may include a filter, a storage tank, a temperature controller (a heating unit or a cooling unit), a water supply nozzle, or the like and may provide drinking water of various temperature conditions to a user. Therefore, the user may be provided with water of various temperatures suited to a taste and a purpose through the water purifier.

Meanwhile, the water purifier 100 is not limited to the above configuration, and commonly refers to an electronic device which may provide drinking water of various temperatures to the user. For example, the water purifier 100 may be a water purifying device included in a refrigerator, a kimchi refrigerator, etc.

The water purifier 100 may include a filter filtering water introduced from the outside, a tank for storing water filtered by a filter, a heat exchanging unit for controlling a temperature of water inside the storage tank, a temperature sensor 150 capable of detecting a temperature of water inside the storage tank, and a water supply unit 30 supplying water filtered by the filter to the user.

The water purifier 100 may filter water introduced from the outside and store it in the storage tank.

The water purifier 100 may control a temperature of water stored in the storage tank through the heat exchanging unit positioned adjacent to the storage tank. Here, the temperature of water may be various temperatures from −10° C. to 100° C. but is not limited thereto.

The water purifier 100 may provide water stored in the storage tank to the user through the water supply unit 30.

The water purifier 100 does not necessarily include the storage tank, wherein it may include a straight pipe without the storage tank to provide drinking water purified by the filter to the user. Specifically, the water purifier 100 may provide drinking water of various temperatures to the user by heating or cooling water passing through the straight pipe through a temperature controller included adjacent to the straight pipe.

The water purifier 100 may perform communication connection with a user terminal 200 (e.g. a smart phone, a tablet PC, a desk top, etc.) through the communication interface 110 to transmit or receive various information.

For example, the water purifier 100 may transmit or receive information about tea to/from the user terminal 200 through the communication interface 110. Here, the information about tea may be information about a type of tea, a method of manufacturing tea, or the like but is not limited thereto.

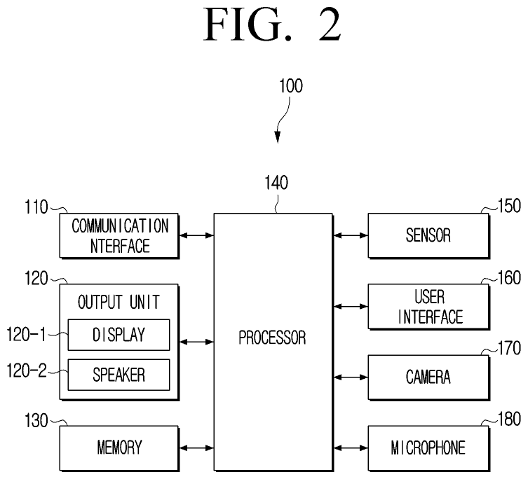

FIG. 2 is a block diagram illustrating a configuration of a water purifier 100 according to an embodiment.

With reference to FIG. 2, the water purifier 100 may include a communication interface 110, an output unit 120 consisting of a display 120-1 or a speaker 120-2, memory 130, and a processor 140.

Besides, the water purifier 100 may additionally include a sensor 150, a user interface 160, a camera 170, and a microphone 180.

The water purifier 100 may additionally include another device configuration for performing operations according to the aspect of the disclosure besides the aforementioned configuration, or part of the configuration may be omitted.

The communication interface 110 may include a wireless communication interface 110, a wired communication interface 110, or an input interface. The wireless communication interface 110 may perform communication with various external devices by using a wireless communication technology or a mobile communication technology. This wireless communication technology may include, for example, Bluetooth, Bluetooth Low Energy, CAN communication, Wi-Fi, Wi-Fi Direct, ultrawide band (UWB), Zigbee, Infrared Data Association (IrDA), or Near Field Communication (NFC), and the mobile communication technology may include 3GPP, Wi-Max, Long Term Evolution (LTE), or 5G.

The wireless communication interface 110 may be implemented by using an antenna, a communication chip, a substrate, and the like which may transmit an electromagnetic wave to the outside or may receive the electromagnetic wave transmitted from the outside.

The wired communication interface 110 may perform communication with various external devices based on a wired communication network. Here, the wired communication network may be implemented by using a physical cable, for example, a pair cable, a coaxial cable, a fiber optic cable, or an Ethernet cable.

Any one of the wireless communication interface 110 and the wired communication interface 110 may be omitted according to an embodiment. Therefore, the water purifier 100 may only include the wireless communication interface 110 or may only include the wired communication interface 110. Furthermore, the water purifier 100 may include integrated communication interface 110 that supports all of wireless connection by the wireless communication interface 110 and wired connection by the wired communication interface 110.

The processor 140 is not limited to a case of including one communication interface 110 performing communication connection in one method and may include a plurality of communication interfaces 110 performing communication connection in a plurality of methods.

The processor 140 may perform communication connection with a user terminal 200, an external server, or an external device through the communication interface 110 to transmit or receive various information.

Specifically, the processor 140 may perform communication connection with a user terminal 200 through the communication interface 110 to receive information about tea. Also, the processor 140 may perform communication connection with the external server through the communication interface 110 to receive the information about the tea.

Based on the received information about the tea, the processor 140 may identify a type of tea and a method of manufacturing tea.

Besides, the processor 140 may perform communication connection with the user terminal 200 through the communication interface 110 to receive evaluation information about tea, and the processor 140 may store information about a corrected method of manufacturing tea based on the received evaluation information.

Also, the processor 140 may perform communication connection with the external server or the external device through the communication interface 110 to receive a blending method of a plurality of tea, information about food corresponding to tea, etc.

The output unit 120 may provide various information or a notification to the user and may include a display 120-1 or a speaker 120-2.

The display 120-1 may include various types of display (120-1) panels such as a Liquid Crystal Display (LCD) panel, an Organic Light Emitting Diode (OLED) panel, an Active-Matrix Organic Light-Emitting Diode (AM-OLED) panel, a Liquid Crystal on Silicon (LcoS) panel, a Quantum dot Light-Emitting Diode (QLED) panel, and a Digital Light Processing (DLP) panel, a Plasma Display Panel (PDP), an inorganic LED panel, and a micro (180) (150) LED panel but is not limited thereto. Meanwhile, the display 120-1 may configure a touch screen together with a touch panel and may be configured of a flexible panel.

The display 120-1 may be implemented as a square shape and a rectangular shape in a 2D form but is not limited thereto, wherein it may be implemented in various forms such as a circular shape, a polygonal shape, and a 3D form.

The processor 140 may control the display 120-1 to display information about tea. Specifically, the processor 140 may control the display 120-1 to display information about at least one of a type of tea, a method of manufacturing tea, a container suitable for infusing tea, a component of water for infusing tea, a temperature of water for infusing tea, a time for infusing tea, or optimum capacity of tea.

The processor 140 may control the display 120-1 to display information or a notification that preparation for infusing tea is completed.

The processor 140 may control the display 120-1 to display information or a notification that infusion of tea is completed to the user.

The processor 140 may control the display 120-1 to display information about blending of tea.

The processor 140 may control the display 120-1 to display information about food corresponding to tea.

A speaker 120-2 may be composed of a tweeter for playing a high range of sound, a mid range for playing a mid range of sound, a woofer for playing a low range of sound, a sub woofer for playing the lowest range of sound, an enclosure for controlling resonance, a crossover network for dividing an electric signal frequency inputted into the speaker 120-2 according to its range.

The speaker 120-2 may output a sound signal to the outside of the water purifier 100. The speaker 120-2 may output multimedia playback, recording playback, various notification sounds, voice messages, etc. The water purifier 100 may include an audio output device such as the speaker 120-2 but may include an output device such as an audio output terminal. In particular, the speaker 120-2 may provide obtained information, information processed and produced based on the obtained information, a response result or an operation result about the user voice, or the like in a voice from.

The processor 140 may control the speaker 120-2 to provide information about tea. Specifically, the processor 140 may control the speaker 120-2 to output information about at least one of a type of tea, a method of manufacturing tea, a container suitable for infusing tea, a component of water for infusing tea, a temperature of water for infusing tea, a time for infusing tea, or optimum capacity of tea.

The processor 140 may control the speaker 120-2 to output information or a notification that preparation for infusing tea is completed.

The processor 140 may control the speaker 120-2 to output information or a notification that infusion of tea is completed to the user.

The processor 140 may control the speaker 120-2 to output information about blending of tea.

The processor 140 may control the speaker 120-2 to output information about food corresponding to tea.

Besides, the processor 140 may control the display 120-1 or the speaker 120-2 to provide information or a notification about tea to the user.

Memory 130 may store temporarily or non-temporarily various programs or data and transmit the stored information to the processor 140 according to a call of the processor 140. Also, the memory 130 may store various information required for an operation, processing, a control operation, or the like of the processor 140 in an electronic format.

The memory 130 may include, for example, at least one of main memory or auxiliary memory. The main memory may be implemented by using a semiconductor storage medium such as ROM and/or RAM. The ROM may include, for example, general ROM, EPROM, EEPROM, and/or MASK-ROM. The RAM may include DRAM and/or SRAM. Auxiliary memory may be implemented by using at least one storage medium which may permanently or semipermanently store data such as a flash memory (130) device, a Secure Digital (SD) card, a solid state drive (SSD), a hard disk drive (HDD), a magnetic drum, an optical medium such as a compact disk (CD), DVD, or a laser disk, a magnetic tape, a magneto-optical disk and/or a floppy disk.

The memory 130 may store information about tea. Specifically, the memory 130 may store information about at least one of a type of tea, a method of manufacturing tea, a container suitable for infusing tea, a component of water for infusing tea, a temperature of water for infusing tea, a time for infusing tea, or optimum capacity of tea.

The memory 130 may store information about a GUI displayed on the display 120-1 for providing information about tea and may store various voice information outputted through the speaker 120-2 for providing information about tea.

The memory 130 may store a blending method of a plurality of tea. The memory 130 may store evaluation information about tea of the user. Here, the evaluation information may be information about a concentration of tea or a taste of tea. The memory 130 may store information about food corresponding to tea.

The memory 130 may store a neural network model. The memory 130 may store a layer, a node, a weight value, or the like included in the neural network model. Here, the neural network model may be a blending model of a plurality of tea or a corrected model of a method of manufacturing tea.

Meanwhile, the disclosure is not limited thereto, and the memory 130 may store various information about tea.

The processor 140 controls operations of the water purifier 100 overall. Specifically, the processor 140 is connected to a configuration of the water purifier 100 including the memory 130 and may control operations of the water purifier 100 overall by executing at least one instruction stored in the memory 130. In particular, the processor 140 may be configured as not only one processor 140 but also a plurality of processors 140.

The sensor 150 may be a temperature sensor 150 but is not limited thereto, wherein it may include various sensors 150 required for manufacturing tea, for example, a weight sensor 150, a flow sensor 150, a motion sensor 150, a gesture sensor 150, etc.

The sensor 150 may detect an operation state or an external environment state (e.g. a user state, a user position, a user gesture, etc.) of the water purifier 100 and generate an electric signal or a data value corresponding to the detected state.

The temperature sensor 150 may be positioned inside a storage tank storing water or at a position adjacent to the storage tank.

The processor 140 may obtain information about a temperature of water stored inside the storage tank through the temperature sensor 150.

Besides, a weight sensor 150 may detect a weight of water stored in the storage tank, and the processor 140 may control a water supply unit 30 to provide water of a weight corresponding to optimum capacity of tea to the user based on weight information of water obtained through the weight sensor 150.

Also, the flow sensor 150 may detect a flow rate of water flowing from the storage tank to the water supply unit 30, and the processor 140 may control the water supply unit 30 to provide water of a volume corresponding to optimum capacity of tea to the user based on flow rate information of water obtained through the flow sensor 150.

The motion sensor 150 may detect a motion of the user positioned around the water purifier 100. The processor 140, if the motion of the user is not detected around the water purifier 100 through the motion sensor 150, may control the water supply unit 30 not to provide water.

The gesture sensor 150 may detect various gestures of the user. The processor 140 may assign instructions corresponding to various gestures of the user. The processor 140 may perform instructions corresponding to the gestures of the user detected through the gesture sensor 150. For example, the processor 140 may detect a hand gesture (e.g. drawing circles, etc.) of the user within a predetermined distance from the water supply unit 30 through the gesture sensor 150 and control the water supply unit 30 to perform a water supply operation which corresponds to instructions corresponding to the detected hand gesture of the user.

The user interface 160 may include a button, a lever, a switch, a touch-type interface, or the like, wherein the touch-type interface may be implemented in a method of receiving an input with a touch of the user on the display 120-1.

The processor 140 may receive various user commands through the user interface 160.

For example, the processor 140 may receive information about tea through the user interface 160. Here, the information about tea may be information about a type of tea, a method of manufacturing tea, a blending method of a plurality of tea, evaluation information about tea or the like but is not limited thereto.

The processor 140 may receive a user command for selecting a temperature of water through the user interface 160. Also, the processor 140 may receive a user command for selecting a volume of water through the user interface 160.

The camera 170 may photograph a static image or a moving image. The processor 140 may obtain various images through the camera 170.

The processor 140 may obtain information about tea based on the image obtained through the camera 170. Here, the information about tea may be information about a type of tea, a method of manufacturing tea, or the like but is not limited thereto.

The processor 140 may identify whether the user is positioned around the water purifier 100 based on the image obtained through the camera 170. Here, the processor 140 may identify whether the user is positioned around the water purifier 100 by utilizing an image classification model. If it is identified that the user is positioned around the water purifier 100 based on the obtained image, the processor 140 may control the water supply unit 30 to provide water to the user, and if it is identified that the user is not positioned around the water purifier 100, the processor 140 may control the water supply unit 30 not to provide water to the user.

The microphone 180 may indicate a module obtaining and converting sound to an electric signal and may be a condenser microphone 180, a ribbon microphone 180, a moving coil microphone 180, a piezoelectric element microphone 180, a carbon microphone 180, or a Micro Electro Mechanical System (MEMS) microphone 180. Also, the microphone may be implemented in an omnidirectional method, a bidirectional method, a unidirectional method, a sub cardioid method, a super cardioid method, or a hyper cardioid method.

The processor 140 may obtain various voices through the microphone 180. The processor 140 may identify a user command or an inquiry included in the voice obtained through the microphone 180.

For example, the processor 140 may identify the user command or the inquiry such as “Give me water.”, “Give me hot water”, “Give me cold water.”, “Let me know a manufacture method of tea.”, “How many minutes does it take to infuse tea?” included in the obtained voice, etc.

Here, the processor 140 may identify a user command included in the voice obtained by utilizing a voice recognition model, a natural language processing model, a Speech to Text (STT) module, or the like.

If the user command or inquiry included in the obtained voice is identified, the processor 140 may control the display 120-1 or the speaker 120-2 to provide various responses corresponding to the identified user command or inquiry.

The processor 140 may be implemented in various methods. For example, the one or more processors 140 may include one or more of a Central Processing Unit (CPU), a Graphics Processing Unit (GPU), an Accelerated Processing Unit (APU), a Many Integrated Core (MIC), a Digital Signal Processor (DSP), a Neural Processing Unit (NPU), a hardware accelerator, or a machine learning accelerator. The one or more processors 140 may control one or any combination of other components of the water purifier 100 and perform an operation related to communication or data processing. The one or more processors 140 may perform one or more programs or instructions stored in the memory 130. For example, the one or more processors 140 may perform a method according to an embodiment of the disclosure by executing one or more instructions stored in the memory 130.

If a method according to an embodiment of the disclosure includes a plurality of operations, the plurality of operations may be performed by one processor 140 and may be performed by a plurality of processors 140. For example, when a first operation, a second operation, and a third operation are performed by a method according to an embodiment, all of the first operation, the second operation, and the third operation may be performed by a first processor 140 and also, the first operation and the second operation are performed by the first processor 140 (e.g. a general purpose processor 140) and the third operation may be performed by a second processor 140 (e.g. an Artificial Intelligence (AI)-dedicated processor 140).

The one or more processors 140 may be implemented as a single core processor 140 including one core and may be implemented as one or more multi core processors 140 including a plurality of cores (e.g. homogeneous multicores or heterogeneous multicores). If the one or more processors 140 are implemented as a multi core processor 140, each of the plurality of cores included in the multi core processor 140 may include processor 140 internal memory 130 such as on-chip memory 130, wherein a common cache shared by the plurality of cores may be included in the multi core processor 140. Also, each of the plurality of cores included in the multi core processor 140 (or part of the plurality of cores) may read and perform program instructions for independently implementing a method according to an embodiment of the disclosure and also, may read and perform program instructions for implementing a method according to an embodiment of the disclosure in connection with all (or part) of the plurality of cores.

If a method according to an embodiment of the disclosure includes a plurality of operations, the plurality of operations may be performed by one core among the plurality of cores included in the multi core processor 140 and may be performed by the plurality of cores. For example, when a first operation, a second operation, and a third operation are performed by a method according to an embodiment, all of the first operation, the second operation, and the third operation may be performed by a first core included in the multi core processor 140 and also, the first operation and the second operation may be performed by the first core included in the multi core processor 140 and the third operation may be performed by the second core included in the multi core processor 140.

In embodiments of the disclosure, the processor 140 may indicate a System on Chip (SoC) onto which one or more processors 140 and other electronic components are integrated, a single core processor 140, a multi core processor 140, or a core included in the single core processor 140 or the multi core processor 140, wherein the core may be implemented as a CPU, a GPU, an APU, a MIC, a DSP, a NPU, a hardware accelerator, or a machine learning accelerator but embodiments of the disclosure are not limited thereto.

The processor 140, if information about tea is received through the communication interface 110, may identify a type of tea based on the received information.

The processor 140 may identify a method of manufacturing tea based on the identified type of tea.

The processor 140 may control a heat exchanging unit such that a temperature of water inside the storage tank reaches a predetermined temperature based on the identified manufacturing method.

The processor 140, if identifying that the temperature of water inside the storage tank detected through the temperature sensor 150 is the predetermined temperature, may control the water supply unit 30 to provide water inside the storage tank to the user.

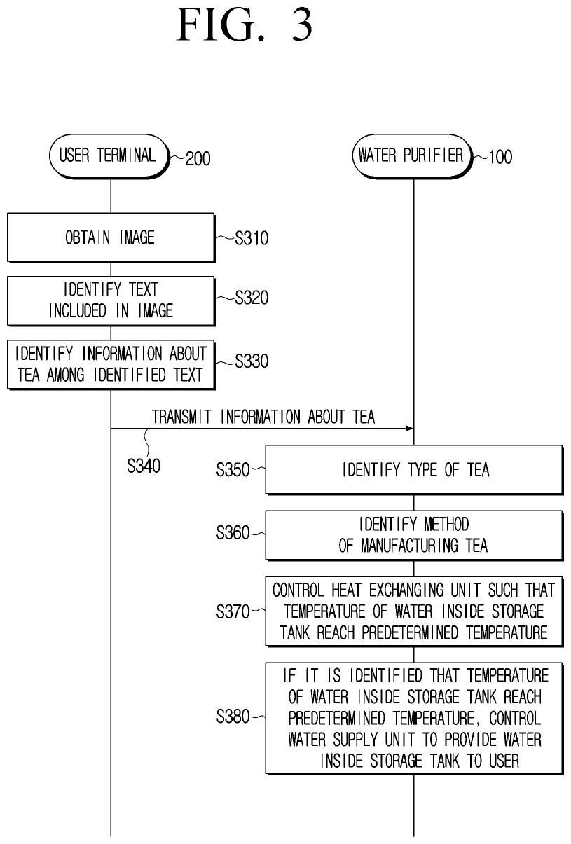

More specifically, an operation of the processor 140 for controlling the water purifier 100 is described together with FIGS. 3 to 10, wherein the description about a control operation with respect to a device configuration of the water purifier 100 to be after-mentioned may be understood as a control operation with respect to the device configuration of the processor 140.

FIG. 3 is a sequence diagram illustrating operations of a water purifier 100 and a user terminal 200 according to an embodiment.

With reference to FIG. 3, the user terminal 200 may obtain an image (S310). The user terminal 200 may obtain an image photographed through the camera 170 or receive an image from the external server or the external device.

The user terminal 200 may identify a text included in the image (S320). The user terminal 200 may identify information about tea among the identified text (S330).

Here, the user terminal 200 may identify a text included in the image in an Optical Character Recognition (OCR) method. The OCR is a method of converting a text image to a text format that may be read by a machine.

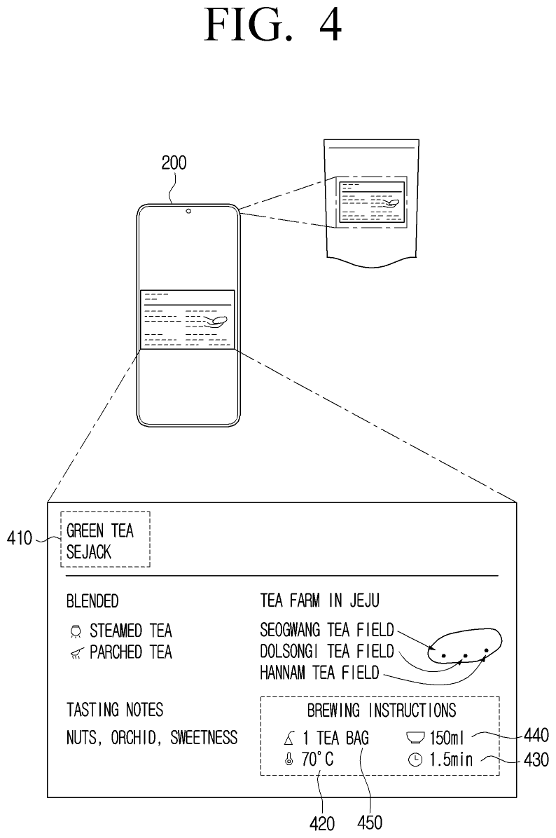

FIG. 4 is a view illustrating operations of obtaining an image in which a wrapper of tea is photographed and identifying a text included in the image through a user terminal 200 according to an embodiment.

With reference to FIG. 4, the user terminal 200 may scan a QR code, a bar code, label information, or the like through the camera 170. The processor 200 may obtain an image with a scan operation through the camera 170. The user terminal 200 may identify a text included in the image. Here, the text included in the image may include information about tea.

The user terminal 200 may identify at least one of information about tea among the text included in the image, specifically, information corresponding to a type of tea 410, information about a temperature of water for infusing tea 420, information about a time for infusing tea 430, information about a volume of water corresponding to optimum capacity of tea 440, or information about capacity of tea 450.

The user terminal 200 may perform communication connection with the water purifier 100 to transmit information about tea (S340). The water purifier 100 may perform communication connection with the user terminal 200 through the communication interface 110 to receive information about tea.

In the above embodiment, it is described that the user terminal 200 identifies the text included in the image and identifies information about tea among the identified text. Meanwhile, the embodiment according to the disclosure is not limited thereto, and the user terminal 200 may transmit the image to the water purifier 100, the water purifier 100 may identify the text included in the image received through the communication interface 110, and identify information about tea among the identified text.

Also, the water purifier 100 may receive information about tea included in a tea database 500 stored in the external server or the external device through the communication interface 110.

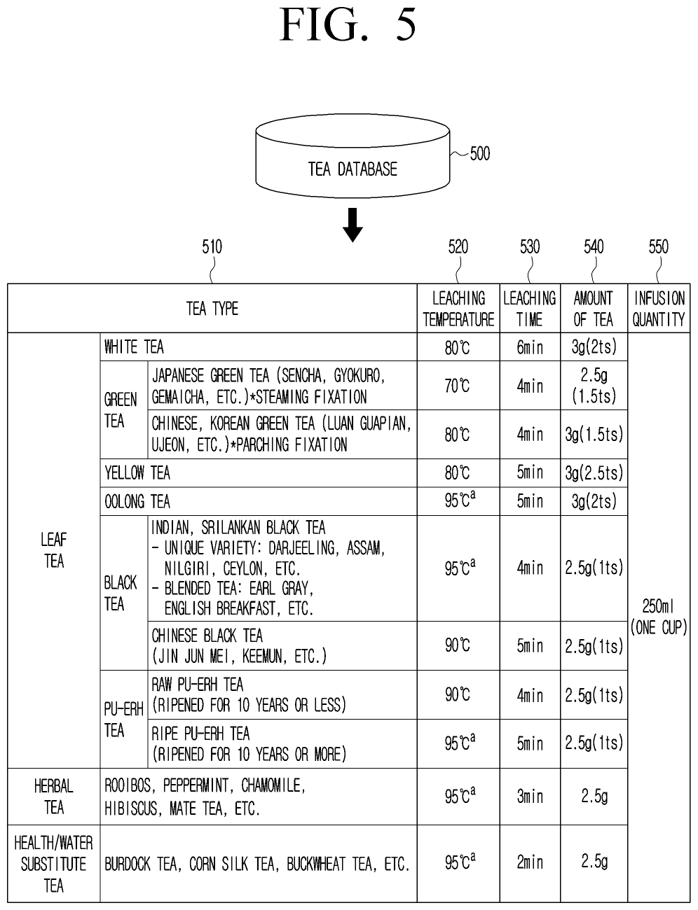

FIG. 5 is a view illustrating a database including information about tea according to an embodiment.

With reference to FIG. 5, the tea database 500 may include information about tea. Specifically, the tea database 500 may include at least one of a type of tea 510, a temperature of water for infusing tea 520, a time for infusing tea 530, optimum capacity of tea 540, or a volume of water corresponding to optimum capacity of tea 550. Besides, the tea database 500 may include information about at least one of a component of water for infusing tea, a material of a container most suitable for infusing tea, or food corresponding to tea.

Therefore, the water purifier 100 may identify at least one of a type of tea 510, a temperature of water for infusing tea 520, a time for infusing tea 530, optimum capacity of tea 540, or a volume of water corresponding to optimum capacity of tea 550 based on information about tea received from the external server or the external device through the communication interface 110.

Besides, the water purifier 100 may receive information about tea through the user interface 160. Also, the water purifier 100 may obtain information about tea based on the image photographed through the camera 170 and obtain information about tea based on a voice obtained through the microphone 180.

The water purifier 100 may identify a type of tea based on information about the identified tea (S350). Here, the type of tea may include, for example, white tea, green tea, yellow tea, oolong tea, black tea, pu-erh tea, herbal tea, corn silk tea, buckwheat tea, etc.

The water purifier 100 may identify a method of manufacturing tea based on the type of tea (S360). Here, the water purifier 100 may identify at least one of a component of water for infusing tea (e.g. lime water, distilled water, rock water), a temperature of water for infusing tea (e.g. 70° C., 100° C.), a time for infusing tea (e.g. 3 minutes, 5 minutes, 7 minutes), or optimum capacity of tea (e.g. 1 g, 3 g, 5 g).

Also, the water purifier 100 may identify pH of water for infusing tea, a volume of water corresponding to optimum capacity of tea (e.g. 250 ml, 300 ml), a material of a container most suitable for infusing tea (e.g. cast iron, clay, ceramics), and food corresponding tea (e.g. Hangwa, Yakgwa, rice cake) based on the type of tea.

The water purifier 100 may control the display 120-1 or the speaker 120-2 to provide at least one of a component of water for infusing tea, a temperature of water for infusing tea, a time for infusing tea, optimum capacity of tea, pH of water for infusing tea, a volume of water corresponding to optimum capacity of tea, a material of a container most suitable for infusing tea, or information about food corresponding to tea to the user.

The water purifier 100 may control a heat exchanging unit such that a temperature of water inside a storage tank reaches a predetermined temperature (S370). Here, the predetermined temperature may be optimum temperature for infusing tea according to the type of tea.

The water purifier 100 may detect a temperature of water inside the storage tank through the temperature sensor 150 to obtain information about the temperature of water.

Here, if it is identified that the temperature of water inside the storage tank detected through the temperature sensor 150 is the predetermined temperature, the water purifier 100 may control the output unit 120 to provide a notification that preparation for infusing tea is completed to the user.

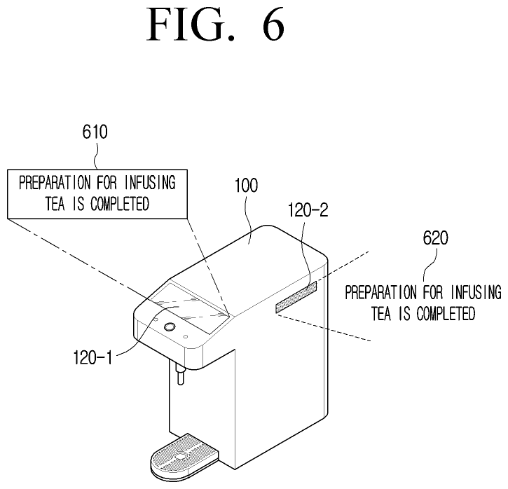

FIG. 6 is a view illustrating an operating in which a water purifier 100 provides a notification that preparation for infusing tea is completed to a user through an output unit 120 according to an embodiment.

With reference to FIG. 6, the water purifier 100 may control a display 120-1 to display a GUI 610 including the phrase “The preparation for infusing tea is completed.”

Also, the water purifier 100 may control the speaker 120-2 to output a voice 620 “The preparation for infusing tea is completed.”

If it is identified that the temperature of water inside the storage tank is the predetermined temperature, the water purifier 100 may control the water supply unit 30 to provide water inside the storage tank to the user (S380).

According to another embodiment, the water purifier 100 may control the water supply unit 30 to provide water of the predetermined temperature based on the user command received through the communication interface 110 or the user interface 160.

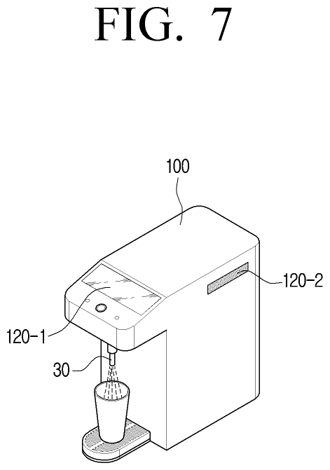

FIG. 7 is a view illustrating an operation in which a water purifier 100 provides water to a user through a water supply unit 30 according to an embodiment.

With reference to FIG. 7, the water purifier 100 may control the water supply unit 30 to supply water to a container positioned outside the water purifier 100.

Also, if a temperature of the water inside the storage tank detected through the temperature sensor 150 is identified as the predetermined temperature, the water purifier 100 may control the water supply unit 30 to provide water of a volume corresponding to optimum capacity of the tea among water inside the storage tank to the user based on a method of manufacturing the tea.

The water purifier 100, if the predetermined time is elapsed from a time point when the water inside the storage tank is provided to the user based on the method of manufacturing the tea, may control the output unit 120 to provide a notification that infusion of the tea is completed to the user.

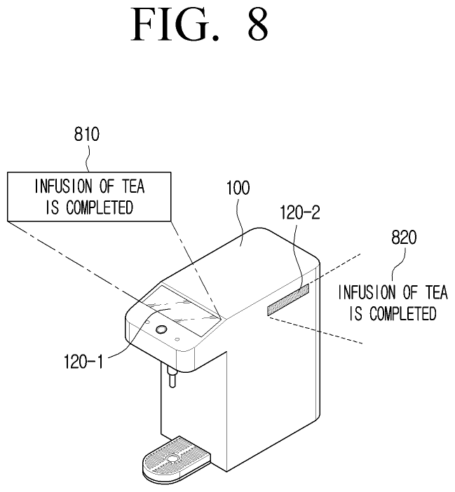

FIG. 8 is a view illustrating an operating in which a water purifier 100 provides a notification that infusion of tea is completed to a user through an output unit 120 according to an embodiment.

With reference to FIG. 8, the water purifier 100 may control a display 120-1 to display a GUI 810 including the phrase “The infusion of tea is completed.”

Also, the water purifier 100 may control the speaker 120-2 to output a voice 820 “The infusion of tea is completed.”

According to another embodiment, if information about a plurality of tea is received through the communication interface 110, the water purifier 100 may identify a type of the plurality of tea based on the received information. Here, the plurality of tea may be different types of tea.

The water purifier 100 may identify a method of blending the plurality of tea based on the identified type of the plurality of tea.

Here, the water purifier 100 may perform communication connection with the external server or the external device through the communication interface 110 to receive blending information of tea and identify the method of blending the plurality of tea.

Also, the water purifier 100 may obtain a vector value corresponding to a blending ratio of the plurality of tea by using a neural network model.

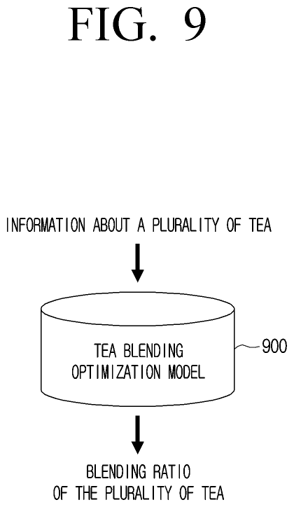

FIG. 9 is a view illustrating an operation in which a water purifier 100 obtains information about a blending ratio of a plurality of tea through a tea blending optimization model 900 according to an embodiment.

With reference to FIG. 9, the neural network model may be the tea blending optimization model 900. Specifically, the water purifier 100 may input information about the plurality of tea to the tea blending optimization model 900 to obtain a vector value corresponding to a blending ratio of the plurality of tea. The water purifier 100 may identify the blending ratio of the plurality of tea based on the obtained vector value.

The water purifier 100 may identify a method of manufacturing blended tea based on the identified blending method.

According to another embodiment, if evaluation information about tea is received from the user through the communication interface 110 or the user interface 160, the water purifier 100 may obtain and store information about a corrected method of manufacturing tea based on the evaluation information.

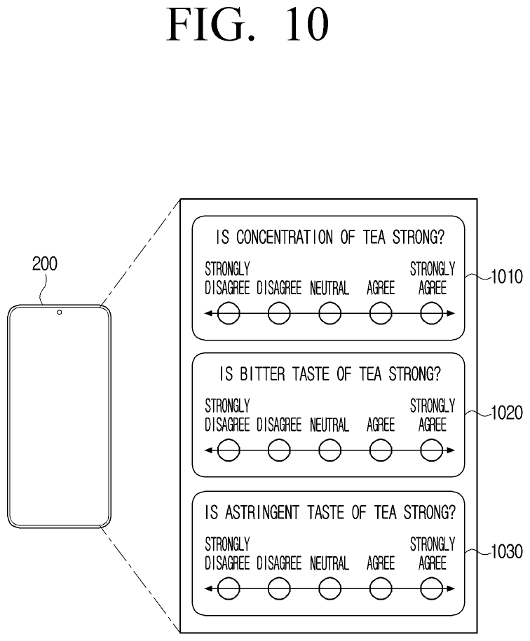

FIG. 10 is a view illustrating an operation of receiving evaluation information about tea from a user according to an embodiment.

With reference to FIG. 10, the user terminal 200 may display a GUI including an inquiry and a response for receiving evaluation information about tea from the user. Here, the inquiry for receiving evaluation information about tea may be an inquiry about a concentration of tea 1010 and an inquiry about a taste of tea 1020, 1030.

Specifically, the user terminal 200 may display the GUI including the inquiry 1010 including the phrase “Is a concentration of tea strong?” The user terminal 200 may receive a response input corresponding to at least one of “Strongly agree”, “Agree”, “Neutral”, “Disagree”, or “Strongly disagree”.

The user terminal 200 may transmit the inquiry about evaluation information about tea and information about the response received from the user to the water purifier 100. The water purifier 100 may perform communication connection with the user terminal 200 through the communication interface 110 to receive the inquiry about evaluation information about tea and information about the response received from the user.

If the response of the user about the inquiry “Is a concentration of tea strong?” is “Agree”, the water purifier 100 may adjust a volume of water corresponding to optimum capacity of tea among a method of manufacturing tea to a volume larger than the previous volume and store the adjusted volume.

Also, the user terminal 200 may display the GUI including the inquiry 1020 including the phrase “Is a bitter taste of tea strong?” The user terminal 200 may receive a response input corresponding to at least one of “Strongly agree”, “Agree”, “Neutral”, “Disagree”, or “Strongly disagree”.

The user terminal 200 may transmit the inquiry about evaluation information about tea and information about the response received from the user to the water purifier 100. The water purifier 100 may perform communication connection with the user terminal 200 through the communication interface 110 to receive the inquiry about evaluation information about tea and information about the response received from the user.

If the response of the user about the inquiry “Is a bitter taste of tea strong?” is “Agree”, the water purifier 100 may adjust a time for infusing tea among a method of manufacturing tea to a time shorter than the previous time and store the adjusted time.

Therefore, if information about the above tea is received thereafter, the water purifier may provide water for infusing tea based on a corrected method of manufacturing tea to provide tea more suited to a taste of the user.

In the example, it is described that the user terminal 200 displays a GUI including an inquiry and a response for receiving evaluation information about tea but the disclosure is not limited thereto, wherein the water purifier 100 may control the display 120-1 to display the GUI including the inquiry and the response for receiving the evaluation information about the tea and control the speaker 120-2 to output sound.

Also, the water purifier 100 may correct and store a method of manufacturing tea by using a neural network model.

Here, the neural network model may be a corrected model of a method of manufacturing tea. Specifically, the water purifier 100 may input the inquiry and the response about evaluation information about tea to the corrected model of the method of manufacturing tea and obtain a vector value corresponding to a volume of water for infusing tea, a temperature for infusing tea, or a time for infusing tea included in the method of manufacturing tea. The water purifier 100 may adjust a volume of water for infusing tea, adjust a temperature for infusing tea, or adjust a time for infusing tea based on the obtained vector value to obtain and store a corrected method of manufacturing tea.

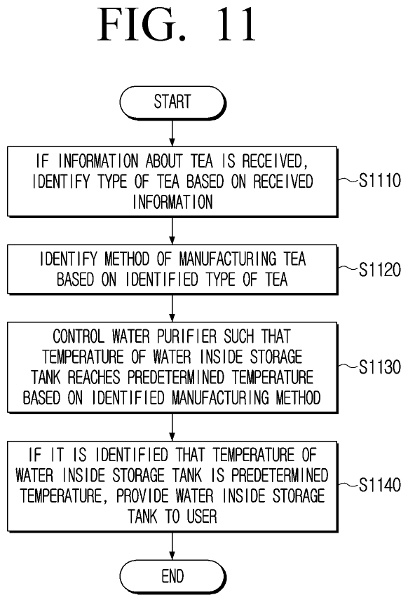

FIG. 11 is a flow chart illustrating an operation of a water purifier 100 according to an embodiment.

The water purifier 100, if information about tea is received through the communication interface 110, may identify a type of tea based on the received information (S1110). “Based on” as used herein covers based at least on.

The water purifier 100 may identify a method of manufacturing tea based on the identified type of tea (S1120).

The water purifier 100 may control a heat exchanging unit such that a temperature of water inside a storage tank reaches a predetermined temperature based on the identified manufacturing method (S1130).

The water purifier 100, if identifying that the temperature of water inside the storage tank detected through the temperature sensor 150 is the predetermined temperature, may control the water supply unit 30 to provide water inside the storage tank to the user (S1140).

A function related to AI according to the disclosure operates through memory and a processor of the electronic device.

The processor may be configured of one or more processors. Here, one or more processors may include at least one of a Central Processing Unit (CPU), a Graphic Processing Unit (GPU), or a Neural Processing Unit (NPU) but are not limited to the aforementioned examples of the processors.

The CPU is a general purpose processor capable of performing not only a general operation but also an AI operation and may efficiently perform a complex program through a multilayer cache structure. The CPU is favorable for a series processing method in which an organic connection between the previous calculation result and the next calculation result is possible through a sequential calculation. The general purpose processor is not limited to the aforementioned examples, excluding a case that the disclosure designates it as the aforementioned CPU.

The GPU is a processor for a mass operation such as a floating point operation used for graphic processing and may integrate cores massively to perform a mass operation in parallel. In particular, the GPU may be favorable for a parallel processing method such as a convolution operation compared to the CPU. Also, the GPU may be used for a co-processor for supplementing a function of the CPU. The processor for the mass operation is not limited to the aforementioned examples, excluding a case that the disclosure designates it as the aforementioned GPU.

The NPU is a processor specific to an AI operation using an artificial neural network, wherein each layer configuring the artificial neural network may be implemented as hardware (e.g. silicon). Here, the NPU is designed to be specific to the specification required by the manufacturer, and thus its degree of freedom is lower than that of the CPU or the GPU but may efficiently perform the AI operation required by the manufacturer. Meanwhile, as a processor specific to the AI operation, the NPU may be implemented as various forms such as a Tensor Processing Unit (TPU), an Intelligence Processing Unit (IPU), or a Vision processing unit (VPU). The AI processor is not limited to the aforementioned examples, excluding a case that the disclosure designates it as the aforementioned NPU.

Also, one or more processors may be implemented as a System on Chip (SoC). Here, the SoC may further include memory and a network interface such as a bus for data communication between a processor and the memory besides one or more processors.

If the SoC included in the electronic device includes a plurality of processors, the electronic device may perform an operation related to AI (e.g. an operation related to learning or inference of the AI model) by using a partial processor among the plurality of processors. For example, the electronic device may perform the operation related to the AI by using at least one of a GPU, a NPU, a VPU, a TPU, or a hardware accelerator specific to the AI operation such as a convolution operation or a matrix product calculation among the plurality of processors. Meanwhile, this is merely an example, and the operation related to the AI may be processed by using a general purpose processor such as a CPU. Each “processor” herein includes processing circuitry, and/or may include multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

Also, the electronic device may perform an operation with respect to a function related to AI by using a multicore (e.g. a dual core, a quad core) included in one processor. In particular, the electronic device may perform the AI operation such as the convolution operation and the matrix product calculation in parallel by using the multicore included in the processor.

The one or more processors may control the electronic device to process input data according to a predefined operation rule stored in the memory or an AI model. The predefined operation rule or the AI model is constructed by learning.

Here, the construction by learning may indicate that the predefined operation rule or the AI model having a desired characteristic is constructed by applying a learning algorithm to various learning data. This learning may be performed in a device itself where the AI according to the disclosure is performed and may be also performed through a separate server/system.

The AI model may be composed of a plurality of neural network layers. At least one layer has at least one weight value and performs an operation of the layer through an operation result of the previous layer and at least one defined operation. An example of the neural network is a Convolutional Neural Network (CNN), a Deep Neural Network (DNN), a Recurrent Neural Network (RNN), a Restricted Boltzmann Machine (RBM), a Deep Belief Network (DBN), a Bidirectional Recurrent Deep Neural Network (BRDNN), a Deep Q-Network, or a Transformer, wherein the neural network of the disclosure is not limited to the aforementioned example, excluding a case that the neural network is designated as the aforementioned example.

The learning algorithm is a method in which a given target device (e.g. a robot) is trained by using a plurality of learning data such that the given target device may make or predict a decision by itself. An example of the learning algorithm is supervised learning, unsupervised learning, semi-supervised learning, or reinforcement learning, wherein the learning algorithm of the disclosure is not limited to the aforementioned example, excluding a case that the learning algorithm is designated as the aforementioned example.

According to an embodiment, a method according to various examples disclosed in the disclosure may be provided to be included in a computer program product. The computer program product may be traded between a seller and a buyer as goods. The computer program product may be distributed in a form of the machine-readable storage medium (e.g. compact disc read only memory (CD-ROM)) or on-line distributed (e.g. downloaded or uploaded) via an application store (e.g. Play Store™) or directly between two user devices (e.g. smart phones). In the case of the on-line distribution, at least part of the computer program product (e.g. a downloadable app) may be stored at least temporarily or may be generated temporarily in the machine-readable storage medium such as memory of a server of a manufacturer, a server of an application store, or a relay server.

As the above, preferable examples of the present disclosure are shown and described. However, the disclosure is not limited to the aforementioned specific examples, and various modifications may be implemented by those skilled in the art without deviating from the gist of the disclosure claimed in the scope of claims, wherein these modifications should not be independently understood from the technical spirit or prospect of the disclosure. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A water purifier comprising:
a filter configured for filtering water to be introduced from an outside;
a storage tank configured for storing the water filtered by the filter;
a heat exchanger” for controlling a temperature of the water inside the storage tank;
a temperature sensor configured for detecting the temperature of the water inside the storage tank;
a water supply configured for supplying water filtered by the filter to a user;
a communication interface comprising communication circuitry;
an output, comprising circuitry, for providing information about tea to the user;
a memory for storing at least one instruction; and
one or more processors, comprising processing circuitry, configured for individually and/or collectively executing the at least one instruction to:
based on the information about the tea being received through the communication interface, identify a type of the tea based on the received information;
identify a method of manufacturing the tea based on the identified type of the tea,
control the heat exchanger such that the temperature of the water inside the storage tank reaches a predetermined temperature based on the identified manufacturing method; and
based on the temperature of the water inside the storage tank detected through the temperature sensor being identified as the predetermined temperature, control the water supply to provide the water inside the storage tank to the user.

2. The water purifier of claim 1, wherein the one or more processors are individually and/or collectively configured to:
identify at least one of: a component of water for infusing the tea, a temperature of water for infusing the tea, a time for infusing the tea, or optimum capacity of the tea.

3. The water purifier of claim 1, wherein the one or more processors are individually and/or collectively configured to:
based on the temperature of the water inside the storage tank detected through the temperature sensor being identified as the predetermined temperature, control the output to provide a notification that preparation for infusing the tea is completed to the user.

4. The water purifier of claim 1, wherein the one or more processors are individually and/or collectively configured to:
based on a predetermined time being elapsed from a time point when the water inside the storage tank is provided to the user based on the method of manufacturing the tea, control the output to provide a notification that infusion of the tea is completed to the user.

5. The water purifier of claim 1, wherein the one or more processors are individually and/or collectively configured to:
based on the temperature of the water inside the storage tank detected through the temperature sensor being identified as the predetermined temperature, control the water supply to provide water of a volume related to optimum capacity of the tea among the water inside the storage tank to the user based on the method of manufacturing the tea.

6. The water purifier of claim 1, wherein the one or more processors are individually and/or collectively configured to:
based on information about a plurality of tea being received through the communication interface, identify a type of the plurality of tea based on the received information;
identify a method of blending the plurality of tea based on the identified type of the plurality of tea; and
identify a method of manufacturing the blended tea based on the identified blending method.

7. The water purifier of claim 1, wherein the one or more processors are individually and/or collectively configured to:
based on evaluation information about the tea being received from the user, store information about a corrected method of manufacturing the tea based on the evaluation information,
wherein the evaluation information comprises information about at least one of a concentration of the tea or a taste of the tea.

8. The water purifier of claim 1, wherein the one or more processors are individually and/or collectively configured to:
control the output to provide information about at least one of: a component of water for infusing the tea, a temperature of water for infusing the tea, a time for infusing the tea, or optimum capacity of the tea based on the identified type of the tea.

9. The water purifier of claim 1, wherein the one or more processors are individually and/or collectively configured to:
identify food corresponding to the tea based on the identified type of the tea; and
control the output to provide information about the identified food to the user.

10. A method of controlling a water purifier, comprising:
based on information about tea being received, identifying a type of tea based on the received information;
identifying a method of manufacturing the tea based on the identified type of the tea,
controlling the water purifier such that a temperature of water inside a storage tank reaches at least a predetermined temperature based on the identified manufacturing method; and
based on the temperature of the water inside the storage tank being identified as at least the predetermined temperature, providing the water inside the storage tank to a user.

11. The method of claim 10, wherein the identifying the manufacturing method includes:
identifying at least one of: a characteristic of water for infusing the tea, a temperature of water for infusing the tea, a time for infusing the tea, or optimum capacity of the tea.

12. The method of claim 10, wherein the control method comprises:
based on the temperature of the water inside the storage tank being identified as the predetermined temperature, providing a notification that preparation for infusing the tea is completed to the user.

13. The method of claim 10, wherein the control method comprises:
based on a predetermined time being elapsed from a time point when the water inside the storage tank is provided to the user based on the method of manufacturing the tea, providing a notification that infusion of the tea is completed to the user.

14. The method of claim 10, wherein the providing the water includes:
based on the temperature of the water inside the storage tank being identified as the predetermined temperature, providing water of a volume related to optimum capacity of the tea among the water inside the storage tank to the user based on the method of manufacturing the tea.

15. A non-transitory computer readable recording medium storing computer instructions that, when executed by a processor of a water purifier, cause the water purifier to:
based on information about tea being received, identify a type of tea based on the received information;
identify a method of manufacturing the tea based on the identified type of the tea;
control the water purifier such that a temperature of water inside the water purifier reaches a predetermined temperature based on the identified manufacturing method; and
based on the temperature of the water inside the water purifier being identified as the predetermined temperature, provide the water inside the water purifier to a user.
